(19) United States
(12) Patent Application Publication
(10) Pub. No.: US 2011/0311315 A1
(43) Pub. Date: Dec. 22, 2011

(54) Friction Bolt Assembly

(75) Inventors: David W. Evans, Rankin Park (AU); Hird Derek Colin, New Lambton (AU); Boychuk Andrew Simon, Warners (AU)

(73) Assignee: DIWIDAG-SYSTEMS INTERNATIONAL PTY LIMITED, Bennett's Green (AU)

(21) Appl. No.: 12/674,387

(22) PCT Filed: Aug. 20, 2008
(86) PCT No.: PCT/AU2008/001220

§ 371 Date: Jun. 13, 2011

(30) Foreign Application Priority Data
Aug. 22, 2007 (AU) 2007904526
Apr. 1, 2008 (AU) 2008901564

(51) Int. Cl. E21D 21/00; F16B 13/04

(52) U.S. Cl. 405/259.3; 411/21

(57) ABSTRACT

A friction bolt assembly (1) comprises a friction bolt (2) with a pre-formed elongate column (3) of flexible, solid material retained within, and extending along a cavity (4) defined by the body (5) of the friction bolt (2). The body (5) of the friction bolt (2) is generally cylindrical and has a split (6) extending along its length.

### TECHNICAL FIELD

The present invention relates to the field of strata control of underground mines and other underground excavations, and in particular relates to a friction bolt assembly.

### BACKGROUND OF THE INVENTION

A current method of stabilising the roof or wall of an underground mine involves the use of friction rock bolts, otherwise known as friction rock stabilisers. Friction bolts have a generally cylindrical body and a collar welded to the trailing end of the body. The leading end portion of the body is tapered to assist in inserting the friction bolt into a bore hole drilled into the rock strata. The body is split down one side such that when it is driven into a slightly undersized hole in the rock strata, the rock bolt elastically deforms to reduce the size of the split in the body. This elastic deformation exerts radial forces against the wall of the hole providing a corresponding frictional force, retaining the friction bolt within the hole. A rock bearing plate is fitted to the body directly above the collar such that the collar bears the rock bearing plate against the rock face of the mine to distribute axial loads carried by the friction bolt across the face of the roof.

When movement of the rock strata occurs, the friction bolt is allowed to deform with the rock strata. It is this deformation of the friction bolt that allows for effective load transfer between the friction bolt and the rock strata. If greater deformation is permitted prior to ultimate failure of the friction bolt, then the effective service life of the bolt may be extended. There has been a recent trend to fill the internal cavity of the friction bolt with a rigid cement based grout either during or post installation of the friction bolt. The grout, once set, becomes rigid. Grouting of the friction bolt is intended to both protect the body of the friction bolt against corrosion and to increase the load bearing capacity of the friction bolt.

Whilst a fully grouted friction bolt provides high resistance to radial compression of the friction bolt body, and thus provides an increased frictional load transfer capacity, the rigid column of grout inhibits the ability of the body of the friction bolt to deform with lateral strata movement, potentially resulting in shear failure of the friction bolt.

Similarly, when a fully grouted friction bolt is placed in tension due to vertical strata movement, the grouted bolt will not be able to adequately elongate over its entire length, due to high frictional resistance between the internal grout column and friction bolt. Within the immediate vicinity of a fault line within the strata and associated vertical strata movement, localised stress concentrations in the friction bolt will occur. In this instance, the localised friction forces between the bolt and strata may become so great that they exceed the tensile strength of the friction bolt, such that the friction bolt fails at the area of localised stress concentration rather than deforming with the rock strata. This can potentially occur with relatively minor vertical displacement of the strata.

Further, the grouting of friction bolts is typically a difficult and/or time consuming process. When adopting a post grouting approach, grout must be pumped into each installed friction bolt after installation. Whilst friction bolt assemblies have been proposed that provide friction bolts preloaded with a grout filled cartridge, these require hydration of the grout, to enable it to set, either immediately before or after installation of the friction bolt. Such hydration of the grout is typically time consuming and introduces moisture to the friction bolt which may lead to the onset of corrosion rather than protecting the rock bolt from corrosion as intended.

### OBJECT OF THE INVENTION

It is the object of the present invention to substantially overcome or at least ameliorate one or more of the above disadvantages.

### SUMMARY OF THE INVENTION

In one aspect, the present invention provides a friction bolt assembly comprising: a friction bolt having a generally cylindrical body split along its length and defining a cavity extending through the length of said body; a pre-formed elongate column of flexible, solid material retained within, and extending along, said cavity. Typically, said column directly engages said body. Typically, said column extends along at least 10% of said length of said cavity. More typically, said column extends from adjacent a leading end of said cavity toward a trailing end of said cavity, leaving a gap for receipt of an installation dolly spigot between said column and said trailing end. Said column may have a generally circular transverse cross-section. Said column may have a transverse cross-section in the general form of a truncated circle defined by a major arc and a cut out portion, said cut out portion being generally aligned with said split.

In one form, said cut out portion is concave. The transverse cross-section of said column may fill a transverse cross-section of said cavity.

Alternatively, said transverse cross-section of said column may be smaller than a transverse cross-section of said cavity prior to installation. Typically, said transverse cross-section of said column fills at least 80%, and more typically at least 85%, of said transverse cross-section of said cavity prior to installation. The transverse cross-section of said column preferably fills at least 90% of said cross-section of said cavity prior to installation. The column may be bonded to said body. In another form, said column may be mechanically secured to said body.

Alternatively, said column may be retained in said cavity by an interference fit with said body. In one form, said column may be retained in said cavity by an interference fit with a tapered leading end portion of said body. The column may also, or alternatively, have a tapered trailing end portion defining a collar that engages a trailing end portion of said body.

The column may have a tapered leading end portion. The tapered leading end portion of said column may be truncated. Typically, said flexible, solid material is fluid impervious. The flexible, solid material may be polymer based. In one particular form, the flexible, solid material comprises a foam. The flexible, solid material may comprise polystyrene, polyurethane, polyethylene, or a synthetic or natural rubber, or a combination of one or more materials. Typically, said flexible, solid material has a Young's modulus of 5 to 40 MPa. Typically, the hardness of the material will be in the order of 80 to 100 durometer A.

In another aspect, the present invention provides a friction bolt installation comprising: a friction bolt assembly as defined above installed in a bore hole in a rock face, said bore hole having a diameter less than a diameter of said body of said friction bolt in an undeformed state, said column substantially filling the transverse cross-section of said cavity.

In another aspect, the present invention provides a method of securing a rock strata, said method comprising: inserting a pre-formed column of solid, flexible material into the cavity of a friction bolt having a generally cylindrical body split along its length; drilling a bore hole in a rock face of said strata, said bore hole having a smaller diameter than a diameter of said body; and driving said friction bolt into said bore hole.

Typically, a transverse cross-section of said column substantially fills the transverse cross-section of said cavity following driving of said friction bolt into said bore hole.

### BRIEF DESCRIPTION OF THE DRAWINGS

Preferred embodiments of the present invention will now be described, by way of an example only, with reference to the accompanying drawings wherein:

FIG. 1 is a front elevation view of a friction bolt assembly;

FIG. 2 is a cross-sectional view of the friction bolt assembly of FIG. 1 taken at section 2-2;

FIG. 3 is a partially cross-sectioned view of a friction bolt installation incorporating the friction bolt assembly of FIG. 1;

FIG. 4 is a schematic cross-sectional view of a friction bolt installation depicting forces associated with strata movement;

FIG. 5 is a partially cross-sectioned view of the friction bolt installation of FIG. 3 further incorporating a mesh installation;

FIGS. 6 through 13 are cross-sectional views of alternate friction bolt assemblies taken through a cross-section equivalent to section 2-2 of FIG. 1;

FIG. 14 is a cross-sectional view of a friction bolt assembly having a preferred column;

FIG. 15 is a perspective view of the column of the friction bolt assembly of FIG. 14;

FIG. 16 is a front elevation view of the column of the friction bolt assembly of FIG. 14;

FIG. 17 is a right side elevation view of the column of the friction bolt assembly of FIG. 14.

FIG. 18 is a fragmentary isometric view of a friction bolt assembly according to an alternative embodiment; and

FIG. 19 is a fragmentary cross-sectional view of the friction bolt assembly of FIG. 18.

### DETAILED DESCRIPTION OF THE PREFERRED EMBODIMENTS

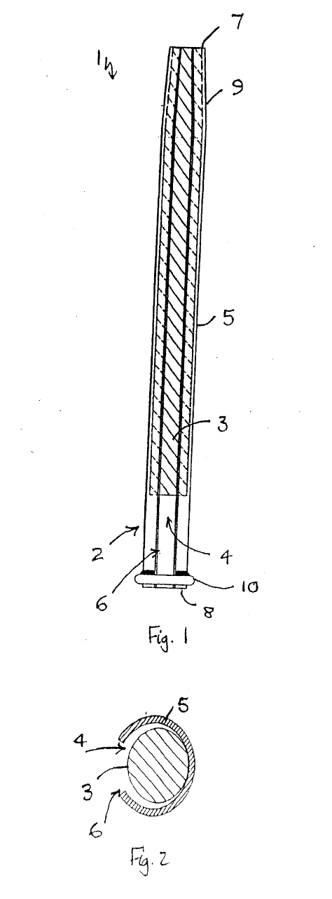

Referring to FIGS. 1 and 2 of the accompanying drawings, a friction bolt assembly 1 comprises a friction bolt 2 with a pre-formed elongate column 3 of flexible, solid material retained within, and extending along, the cavity 4 defined by the body 5 of the friction bolt 2. The body 5 of the friction bolt 2 is of a standard form, being generally cylindrical and having a split 6 extending along its length. The cavity 4 defined by the body 5 of the friction bolt 2 extends through the length of the friction bolt 2 from the leading end 7 of the friction bolt 2 to the trailing end 8 of the friction bolt 2. The leading end portion 9 of the body 5 of the friction bolt 2 is tapered in the usual manner to enable the friction bolt 2 to be driven into a bore hole having a smaller diameter than the diameter of the remaining length of the body 5 of the friction bolt 2. A collar 10, in the general form of a torus, is welded to the body 5 of the friction bolt 2 adjacent the trailing end 8 in the usual manner.

The column 3 may be retained within the cavity 4 by bonding the column 3 to the body 5 of the friction bolt 2, typically on a portion of the interior wall of the body 5 of the friction bolt 2 that opposes the split 6, as depicted in FIG. 2. Any suitable adhesive may be utilised for this purpose. Alternatively, the column 3 may be sized so as to provide an interference fit with the tapered portion 9 of the body 5 of the friction bolt 2.

The column 3 is typically generally cylindrical, having a generally circular cross-section as depicted in FIG. 2. The column 3 may be extruded, and cut into desired lengths or otherwise cast or injection moulded. The column 3 is typically loaded into the friction bolt 2 prior to delivery on site.

In the arrangement depicted in FIG. 2, the transverse cross-section of the column 3 is smaller than the transverse cross-section of the cavity 4. Typically, the cross-section of the column 3 will fill at least about 80%, and more typically at least about 85%, of the transverse cross-section of the cavity 4 when the friction bolt is in the undeformed pre-installed state. This will allow for some uninhibited reduction in the cross-section of the cavity 4 as the body 5 of the friction bolt 2 is compressed during installation (as discussed below). In a preferred form, the cross-section of the column 3 will fill at least 90% of the transverse cross-section of the cavity prior to installation. In another form, the cross-section of the column fills the entirety of the transverse cross-section of the cavity 4 when the friction bolt 2 is in the undeformed pre-installed state. This will provide for some compression of the column 3 during installation resulting in greater radial compressive forces between the body 5 of the friction bolt and the surrounding rock strata.

The column 3 here extends from the leading end 7 of the friction bolt towards the trailing end 8 of the friction bolt 2. A gap is left between the column 3 and the trailing end 8 of the friction bolt for receipt of the spigot of an installation dolly used to install the friction bolt 2. Typically, such a spigot extends about 100 mm into the cavity 4, such that the gap should have a length of at least 100 mm. In friction bolt installations where maximum corrosion protection is desired, the column 3 will extend along the full length of the cavity 4, apart from the gap at the trailing end for receipt of the installation dolly spigot. In friction bolt installations where corrosion protection is not such an issue, however, and a point anchor is desired at the leading end 7 of the friction bolt 2, a column 3 of shorter length typically extending over at least 10% of the length of the cavity 4 may be located in the leading end portion of the cavity 4.

The flexible, solid material of the column 3 may be any of various materials, and is preferably a fluid impervious material so as to prevent water ingress, thereby protecting the friction bolt 2 against corrosion. A particularly suitable form of material is a polymer based foam. The material may comprise polystyrene, urethane, polyurethane, polyethylene or a synthetic or natural rubber. The column may be formed from recycled rubber tyres. Typically, the compressive Young's modulus of the material would be in the order of 5 to 40 MPa. The material will also typically have a hardness of the order of 80 to 100 durometer A.

It is envisaged that two separate columns of differing material properties may be mounted in the cavity 4 or alternatively a single column 3 having regions of different material properties as desired. For example, a first column may be located in the leading end portion of the cavity 4 formed of a relatively stiffer material, such as polyurethane, to provide a part anchor with a second column extending along the remainder of the cavity 4 and being formed of a less stiff filler material, such as polystyrene foam, primarily to provide corrosion resistance.

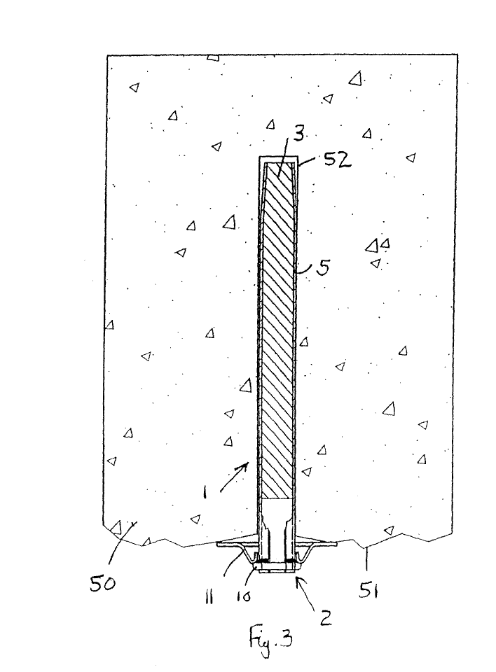

FIG. 3 depicts a friction bolt installation utilizing the friction bolt assembly 1. A blind bore hole 52 is drilled through the rock face 51 of a rock strata 50 to be supported in the usual manner. As with known friction bolt installations, the diameter of the bore hole 52 will typically be slightly less than the external diameter of the body 5 of the friction bolt 2. For example, for a friction bolt having a body diameter of 47 mm, the bore hole 52 will have a diameter of about 43 to 45.5 mm. A bearing plate 11 is mounted on the body 5 of the friction bolt 2 in the usual manner prior to installation, and the friction bolt 2 is then driven into the bore hole 52 utilising a standard installation rig, again in the usual manner, until the collar 10 of the friction bolt 2 bears the bearing plate 11 against the rock face 51. As the body 5 of the friction bolt 2 is driven into the bore hole 52, the body 5 compresses, at least partially closing the split 6 and reducing the cross-sectional diameter of the cavity 4. As a result, the column 3 at least substantially fills the transverse cross-section of the cavity 4. For the above described example with a 47 mm external diameter of the body 5 of the friction bolt, a bore hole with a diameter of 43 to 45.5 mm and a body wall thickness of 3.2 mm, the cavity 4 will have a diameter of the order of 36.6 to 39.1 mm. Accordingly, configuring the column 3 to have a diameter of this order, or slightly greater, will result in the column 3 at least substantially filing the cross-section of the cavity 4, thereby inhibiting the ingress of moisture along the length of the friction bolt.

The column 3 will provide some resistance to radial compression of the body 5 of the friction bolt 2, providing a corresponding increase in friction forces between the friction bolt 2 and strata 50. However, the flexible nature of the column 3 will still allow for some radial compression and elongation of the friction bolt 2 with corresponding movement of the strata. The preferred deformation characteristics of the friction bolt 2 will thus be maintained.

The structural effect of the flexible column 3 on a friction bolt can be understood with reference to FIG. 4. The use of a column 3 of solid, flexible material to substantially fill the cavity 4 of the body 5 of the friction bolt 2 provides an increase in the radial compressive forces (FR) transferred between the strata 50 and the body 5 of the friction bolt 2. There is also a corresponding increase in the frictional force (FF) transfer capacity between the strata 50 and body 5 of the friction bolt 2 beyond that of a standard friction bolt without any filling of the cavity 4. However, because the column 3 is flexible some radial compression of the body 5 of the friction bolt 2 is still permitted. This assists in avoiding excessive values of radial compressive force (FR) where the resulting frictional force (FF) may exceed the ultimate tensile strength of the material from which the body 5 of the friction bolt 2 is formed. Because compression of the body 5 of the friction bolt 2 is permitted, stress induced in the bolt material by the strata movement at an area A corresponding to a fault line 53 between two separated strata planes 50a, 50b can be distributed over a greater length of the body 5 of the friction bolt 2 than if compression were prevented. Thus the body 5 of the friction bolt 2 can achieve greater elongation and an extended effective life, prior to the ultimate tensile strength of the material of the body 5 of the bolt 5 being exceeded.

In comparison, where a rigid material, such as a cement based grout, is used to fill the cavity 4 of the body 5 of the friction bolt 2, radial compression of the friction bolt is restricted under the further action of the radial compressive forces (FR). The wall of the body of the friction bolt would become “pinched” between the strata and the column of grout at very high radial compressive forces (FR). As the two strata planes 50a, 50b separate, localised tensile forces would act immediately in the vicinity of area A. Because of the very high radial forces, deformation of the elongation of the body of the friction bolt is restricted to a short, localised segment of the friction bolt. The ultimate tensile strength of the friction bolt material can be exceeded over a relatively minor displacement of the strata and premature failure of the bolt may occur.

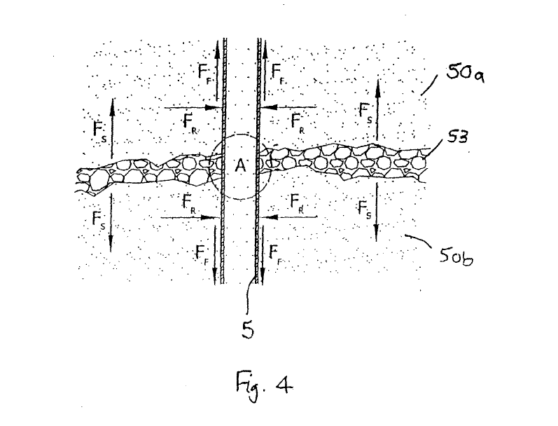

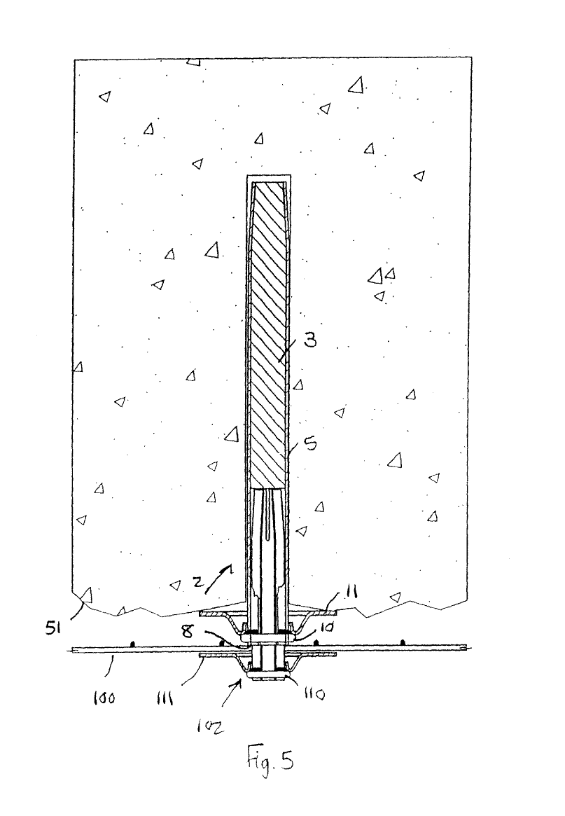

A further advantage of the use in the column 3 of flexible, solid material in the cavity 4 of the body 5 of the friction bolt 2 is the ability to use the friction bolt installation as an anchoring point for mesh pinning operations, as depicted in FIG. 5. For non-grouted friction bolt installations, the cavity 4 of the friction bolt is often utilised for anchoring a further friction bolt 102, with the further friction bolt 102 driven into the cavity 4 of the installed friction bolt 2 from the leading end 8 of the installed friction bolt 2. Wire mesh 100 can then be secured to the rock face 51 between a further bearing plate 111 mounted on the further friction bolt 102 adjacent the collar 110 of the further friction bolt 102 and the collar 10 of the installed friction bolt 2. As depicted in FIG. 5, with the column 3 being flexible, it is possible to drive the further friction bolt 102 into the cavity 4 and through the trailing portion of the column 3. This is not possible when rigid material, such as cement based grout is utilised to fill the cavity 4 of the installed friction bolt 2.

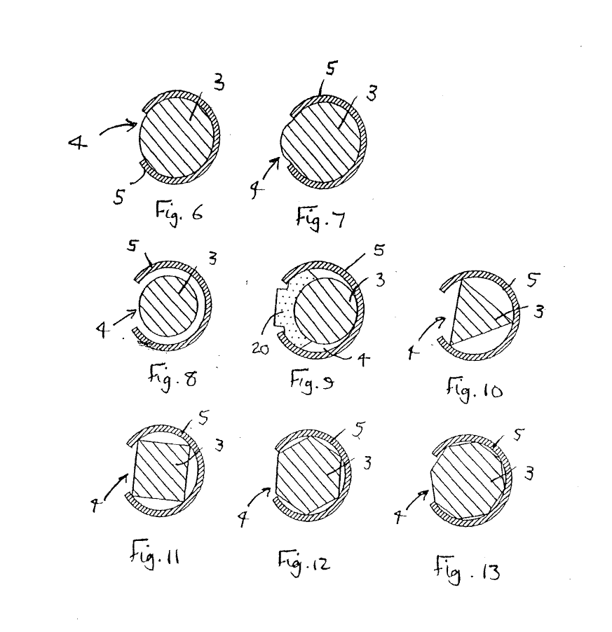

FIGS. 6 through 13 depict various possible alternate cross-sections of the column 3 within the cavity 4 of the body 5 of the friction bolt 2. In the configuration of FIG. 6, the column 3 completely fills the transverse cross-section of the cavity 4 in the undeformed state, such that some compression of the column 3 results during installation of the friction bolt assembly. This will result in increased radial compressive forces between the body 5 of the friction bolt 2 and the rock strata after installation. In the arrangement depicted in FIG. 9, one or more retainers 20 may be utilised to retain the column 3 within the cavity 4, rather than relying on bonding of the column 3 or an interference fit with the tapered end portion of the body 5 of the bolt 2. FIG. 10 through 13 depict various possible non-circular cross-sections of the column.

A person skilled in the art will appreciate that various other cross-sections may be utilised. Similarly, a person skilled in the art will appreciate that various materials will be suitable for fabrication of the column in various lengths.

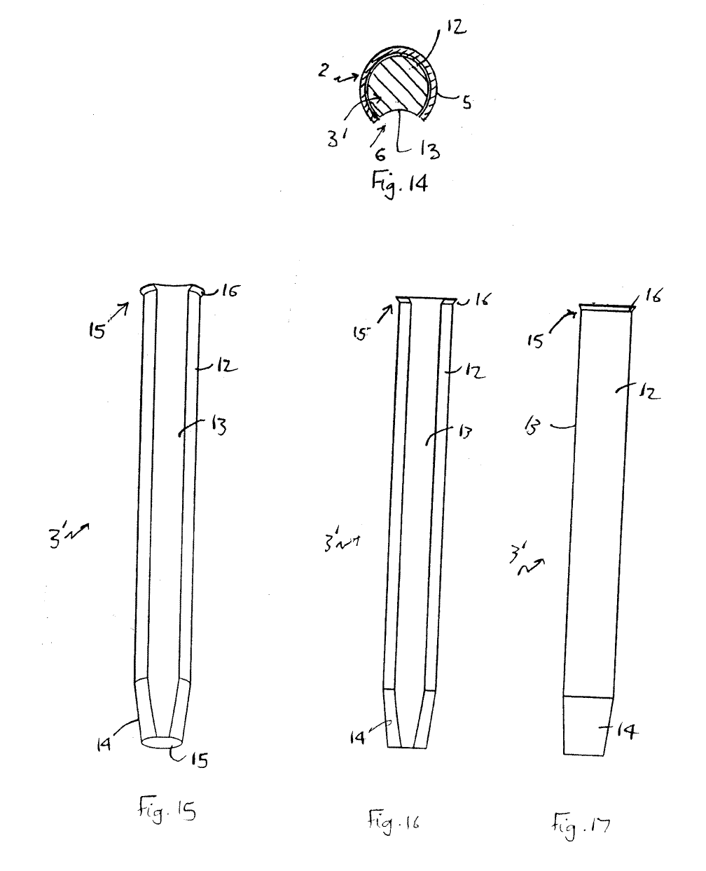

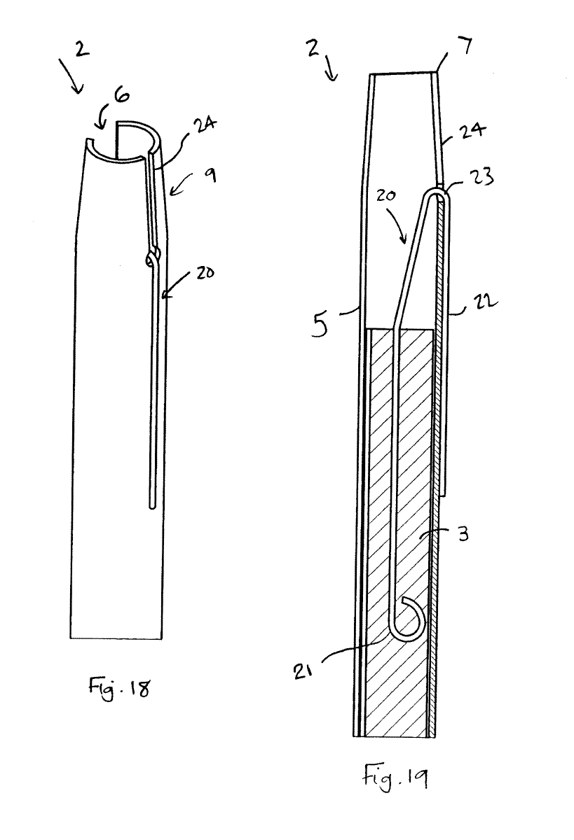

A friction bolt assembly having a particularly preferred column 3′ is depicted in FIG. 14, with the column 3′ depicted in greater detail in FIGS. 15 to 17. The column 3′ has a cross-section that is in the form of a truncated circle defined by a major arc 12 and a cut out portion 13. It can be seen from FIG. 14 that the cut out section 13 is generally aligned with the split 6 of the body 5 of the friction bolt 2. In the arrangement depicted, the cut out portion 13 is concave. Rather than the concave cut out portion 13, any other form of truncation of the circular cross-section extending across the split 6, including a flat cut out portion, may be utilised as desired. Truncating the cross-section of the column 3′ in this manner avoids, or at least reduces, any bulging of the column 3′ from the cavity 4 through the split 6 when the body 5 of the friction bolt 2 is compressed during installation. Such bulging of the column 3′ might otherwise result in the bulged portion of the column 3′ protruding beyond the body 5 of the friction bolt 2 so as to engage with the wall of the bore hole 52. This may tend to drag the column 3′ from the cavity 4 as the friction bolt 2 is driven into the bore hole 52. The concave cut out portion 13 also allows for stacking of friction bolt assemblies (or columns in isolation) in a nested arrangement for packaging and transport.

The leading end portion 14 of the column 3′ is tapered so as to aid the guidance of the column 3′ into the cavity 4 during assembly of the friction bolt assembly. The tapered leading end portion 14 also allows the column 3′ to be driven slightly into the tapered leading portion of the friction bolt 2 when the column 3′ is first loaded into the friction bolt 2, thereby assisting in keeping the column 3′ in place. Also, when the friction bolt assembly is installed into the bore hole 52, it is the leading tapered portion of the friction bolt 2 that is first compressed, gripping the tapered leading portion 14 of the column 3′, helping to prevent the column 3′ from being pushed back down the friction bolt 2. The tapered leading end portion 14 is truncated, providing a flat end surface 15 rather than a tapered point without such truncation. This assists in preventing a narrow leading portion of the column 3′ from bulging beyond the leading end of the body 5 of the friction bolt 2. Such a bulge in this location may otherwise impinge on the blind end of the bore hole 52, again tending to push the column 3′ back out of the cavity 4 of the body 5 of the friction bolt 2.

The column 3′ is also provided with a tapered trailing end portion 15 in the form of a tapered collar 16 that extends about the circular portion of its cross-section. The major diameter of the collar 16 is designed to have an interference fit with the body 5 of the friction bolt 2 prior to installation so as to retain the column 3′ in the cavity 4 of the body 5 of the friction bolt 2. The remainder of the length of the column 3′ has a diameter slightly less than the undeformed diameter of the cavity 4 to assist in ease of assembly of the friction bolt assembly.

In place of, or in addition to, the tapered collar 16, it is envisaged that a nail, or other object, may be driven through the split 6 directly into the trailing end portion 15 of the column 3 once the column has been installed into the cavity 4 so as to locally expand the trailing end portion 15 and provide an interference fit. The column 3 could alternatively (or additionally) be directly secured to the body 5 of the friction bolt 2 by a mechanical fastener such as a screw.

As a further alternative, the trailing end of the body 5 of the friction bolt 2 could be crimped or otherwise deformed so as to pinch the column to retain it in place. The trailing end of the body 5 of the friction bolt 2 could be crimped in various manners, including by providing two opposing indents each offset at 90° from the split 6 in the body 5 of the friction bolt 2, causing the internal distance between the crimped points to be smaller than the outer diameter of the column 3. Alternatively, crimping could be in the form of an indent extending about the whole circumference of the body 5 of the friction bolt 2, causing the interior diameter of the body 5 at that point to be smaller than the outer diameter of the column 3.

In a further alternative configuration for retaining the column 3 within the cavity 4 of the body 5 of the friction bolt 2, a protruding tab could be affixed to the body 5 of the friction bolt 2. Such a tab could be welded to the body 5 or pressed out of the profile of the body 5. The tab could be configured as a physical detent engaging the end face of the column 3, or alternatively could protrude into the column 3 (or a recess formed therein), so as to form a physical obstacle against movement of the column 3.

For configurations where the column 3 is to be bonded to the body 5 of the friction bolt 2, a longitudinally extending slot may be formed along the length of the column 3 for injection of adhesive after the column 3′ has been inserted into the cavity 4 of the body 5 of the friction bolt 2. The slot may be located on the opposing side of the column 3′ to the cut out portion 13.

In a further alternative embodiment, the column 3 may be provided with a roughened surface, such as by application of a surface coating with embedded abrasive media, to assist in retaining the column 3 within the cavity 4 by friction. The surface coating may be, for example, a paint or an adhesive. In the case of an adhesive, the adhesive will additionally secure the column 3 by adhesive bonding.

In another embodiment depicted in FIGS. 18 and 19, a rigid wire hook 20 may be cast into the column 3 so as to project therefrom. The hook 20 typically projects from the leading end of the column 3 so as to engage the leading end portion of the friction bolt 2. The hook 20 has a coiled anchor 21 formed at one end so as to anchor the hook 20 within the column 3 and a bent over tail 22 formed at the opposing end that extends back along part of the length of the body 5 of the friction bolt 2. The hook 20 here engages a slot 24 formed in the tapered leading end 9 of the friction bolt 2 opposing the split 6. The slot 24 also provides for the tapering of the tapered leading end 9 and would typically be applicable to other embodiments of the friction bolt 2. The bend 23 formed in the hook 20 adjacent the tail 22 engages the base of the slot 24 so as to prevent the column 3 from being displaced toward the trailing end of the friction bolt 2. Rather than the rigid wire hook 20, a chain could be arranged to protrude from the column 3 and engage the body 5 of the friction bolt 2 in a similar manner. As another alternative, a flexible wire could be arranged to protrude from the column 3 and be tied or looped onto the tapered leading end portion 9 of the friction bolt 2. The hook will typically engage a slot formed in the tapered leading end portion 9 of the friction bolt 2 opposing the slot 6.

A specific example of the column 3′ is formed of a urethane material with a hardness of 90 durometer A and has a diameter of 38 mm. In a pull-out test utilising this column 3′ in a friction bolt having a nominal outer diameter of 47.0 mm and nominal inner diameter of 40.6 mm installed in a bore hole drilled with a 43 mm drill bit, a pull-out tensile load of 16 tonne was applied to the friction bolt without any dislodging of the friction bolt. For equivalent installations without any column, pull-out loads of only 12 tonne are generally considered to be a very good result.

1. A friction bolt assembly comprising:
a friction bolt having a generally cylindrical body split along its length and defining a cavity extending through the length of said body;
a pre-formed elongate column of flexible, solid material retained within, and extending along, said cavity.

2. The assembly of claim 1, wherein said column directly engages said body.

3. The assembly of claim 1, wherein said column extends along a east 10% of said length of said cavity.

4. The assembly of claim 1, wherein said column extends from adjacent a leading end of said cavity toward a trailing end of said cavity, leaving a gap for receipt of an installation dolly spigot between said column and said trailing end.

5. The assembly of claim 1, wherein said column has a generally circular transverse cross-section.

6. The assembly of claim 1, wherein said column has a transverse cross-section in the general form of a truncated circle defined by a major arc and a cut out portion, said cut out portion being generally aligned with said split.

7. The assembly of claim 6, wherein said cut out portion is concave.

8. The assembly of claim 1, wherein the transverse cross-section of said column fills a transverse cross-section of said cavity.

9. The assembly of claim 1, wherein said transverse cross-section of said column is smaller than a transverse cross-section of said cavity prior to installation.

10. The assembly of claim 1, wherein said transverse cross-section of said column fills at least 80%, of said transverse cross-section of said cavity prior to installation.

11. The assembly of claim 1, wherein said transverse cross-section of said column fills at least 85% of said transverse cross-section of said cavity prior to installation.

12. The assembly of claim 1, wherein said transverse cross-section of said column fills at least 90% of said cross-section of said cavity prior to installation.

13. The assembly of claim 1, wherein said column is bonded to said body.

14. The assembly of claim 1, wherein said column is mechanically secured to said body.

15. The assembly of claim 1, wherein said column is retained in said cavity by an interference fit with said body.

16. The assembly of claim 1, wherein said column is retained in said cavity by an interference fit with a tapered leading end portion of said body.

17. The assembly of claim 1, wherein said column has a tapered trailing end portion defining a collar that engages a trailing end portion of said body.

18. The assembly of claim 1, wherein said column has a tapered leading end portion.

19. The assembly of claim 18, wherein said tapered leading end portion of said column is truncated.

20. The assembly of claim 1, wherein said flexible, solid material is fluid impervious.

21. The assembly of claim 1, wherein said flexible, solid material is polymer based.

22. The assembly of claim 1, wherein said flexible, solid material comprises a foam.

23. The assembly of claim 1, wherein said flexible, solid material comprises polystyrene, polyurethane, polyethylene and/or or a synthetic or natural rubber.

24. The assembly of claim 1, wherein said flexible, solid material has a Young's modulus of 5 to 40 MPa.

25. The assembly of claim 1, wherein said flexible, solid material has a hardness of 80 to 100 durometer A.

26. A friction bolt installation comprising:
the friction bolt assembly of claim 1 installed in a bore hole in a rock face, said bore hole having a diameter less than a diameter of said body of said friction bolt in an undeformed state, said column substantially filling the transverse cross-section of said cavity.

27. A method of securing a rock strata, said method comprising:
inserting a pre-formed column of solid, flexible material into the cavity of a friction bolt having a generally cylindrical body split along its length;
drilling a bore hole in a rock face of said strata, said bore hole having a smaller diameter than a diameter of said body; and
driving said friction bolt into said bore hole.

28. The method of claim 27, wherein a transverse cross-section of said column substantially fills the transverse cross-section of said cavity following driving of said friction bolt into said bore hole.
